(19) United States
(12) Patent Application Publication
(10) Pub. No.: US 2019/0170369 A1
(43) Pub. Date: Jun. 6, 2019

(54) DEVICE OPERATING AT HIGH TEMPERATURE COMPRISING AN INSULATING PRODUCT, INSULATING PRODUCT SUITABLE FOR SUCH A DEVICE, AND PROCESSES FOR USING AND OBTAINING SUCH AN INSULATING PRODUCT

(71) Applicant: SAINT-GOBAIN ISOVER, Courbevoie (FR)

(72) Inventors: Olivier PONS Y MOLL, Agnetz (FR); Maria FABRA PUCHOL, Chamant (FR)

(73) Assignee: SAINT-GOBAIN ISOVER, Courbevoie (FR)

(21) Appl. No.: 16/092,521

(22) PCT Filed: Mar. 29, 2017
(86) PCT No.: PCT/FR2017/050726

§ 371 Date: Oct. 10, 2018

(30) Foreign Application Priority Data
Apr. 11, 2016 (FR) 1653168

(51) Int. Cl. F24C 15/34

(52) U.S. Cl. CPC F24C 15/34; C04B 30/02

(57) ABSTRACT

The invention relates to a device, which operates at high temperature, in particular up to 550° C., and in particular between 50 and 350° C., such as an oven or a part of an oven, this device being equipped with at least one insulating product formed from at least one insulating material ,based>on aerogel(s), advantageously in the form of at least one layer, in particular of at least one fibrous layer. based on aerogel(s), said product comprising less than 0.55% by weight of hydrophobizing agent(s).

The invention also relates to the insulating product suitable for this device and to the use of this product for a high-temperature application.

The present invention relates to a piece of equipment (or appliance or device) capable of operating at high temperature, in particular at temperatures up to 550° C. and in particular between 50 and 350° C., such as a cooking oven, in particular an oven intended for domestic use, and also to a thermal insulation product suitable for insulating said piece of equipment or said oven, in particular suitable for insulating heating boxes of said ovens.

It is known to insulate parts or components of the oven, for example the cooking (or heating) enclosure (or chamber or box), or components such as one or more sources of lighting of the oven, in order to protect in particular the oven components present around the enclosure or the external parts of the oven, from the heat or from overheating, and also in order to prevent heat losses outside the enclosure, this insulation thus making it possible to improve the energy performance levels of the cooking oven when it is used. The insulators used must be able to withstand the high temperatures to which they are exposed and to retain their insulating performance levels at these temperatures without risk of degradation or of emissions that are potentially dangerous to the health.

Ovens are usually insulated with fibrous insulators, based in particular on synthetic fibers such as glass wool or rock wool, for example using insulating layers based on fabrics of glass or mineral wool fibers, the thermal performance levels of these insulators resulting in values of thermal conductivity A (measured in particular according to standard ISO 8302) of greater than 32-35 mW/m.K, in particular of about 40 mW/m,K, at ambient temperature, these values quickly increasing however with the temperature (for example being about 60 mW/m.K at 200° C., about 90 mW/m.K at 300° C. and about 120 mW/m.K at 400° C.) and the usual energy consumption of the ovens remaining relatively high.

Most of the other insulators that exist in other applications are not, for their part, generally suitable for the insulation of equipment subjected to high temperatures, since these materials have, as appropriate, better thermal performance levels at ambient temperature but that can degrade or lose their good thermal performance levels at high temperature or over time. It is the case, for example, with cellular organic insulators such as expanded polymer or foams, these materials degrading in particular at high temperature. In the same way, vacuum insulators, just like aerogels, are not conventionally used in ovens, since these insulators, by virtue of their nature and/or constitution and/or components, have potential risks of degradation or of loss of thermal performance levels at high temperature.

Even though the usual ovens are satisfactory, manufacturers of electrical goods, just like users, still demand improvements in performance levels in terms of energy consumption of ovens, with products that are functional and efficient as soon as they are first used, and are solidly and safely built, these products retaining their performance levels over time.

The present invention thus seeks to develop a novel piece of equipment (or appliance or device), which is in particular a domestic or household piece of equipment, which operates at high temperature (in particular between 50 and 350° C.), such as a cooking oven, and which has good thermal performance levels over its entire temperature range for use (in particular between 50° C. and 350° C.), and also an improved energy consumption, this piece of equipment possibly also being used efficiently and without risk from the first time it is used.

This objective has been achieved by the device (or appliance) according to the invention, operating at high temperature (that is to say above ambient temperature), in particular up to 450° C. or even 550° C., and in particular between 50 and 350° C., this device comprising (or being equipped with or coated with) at least one insulating product, said product being formed from at least one (thermally) insulating material based on aerogel(s), advantageously in the form of at least one layer, in particular of at least one fibrous layer, based on aerogel(s) (or containing aerogels), said product comprising less than 0.55% by weight of hydrophobizing agent(s), in particular less than 0.5%, advantageously less than 0.4%, or even less than 0.25%, in particular less than 0.1%, or even less than 0.05% by weight of hydrophobizing agent(s), and preferably being devoid of hydrophobizing agent(s).

As subsequently indicated and preferably according to the invention, the content of organic components in the abovementioned insulating product is also less than 5.5% by weight of said product, in particular less than 3%, preferably less than 1.65%, the product possibly being in particular solely mineral

The present invention also relates to the thermal insulation product (or insulator or insulating product) suitable for insulating the abovementioned (usable at) high temperature device, and to the use thereof in this application, this product possibly being obtained in various ways (in particular directly, or else from existing products by virtue of a treatment (or transformation) process), and also to a possible process for obtaining said product from existing insulating products.

The insulating product according to the invention, in particular suitable (or intended) for insulating ovens (in particular for domestic use), is a product formed from at least one (thermally) insulating material formed (at least partly) from aerogel(s) (or based on an aerogel or aerogels or containing aerogels or aerogel), said product or material advantageously being in the form of at least one insulating layer, in particular of at least one fibrous (or fiber-based) layer (or lap) containing aerogel or aerogels, said material (or said layer) comprising in particular from 25% to 95% by weight of aerogel(s) (and generally from 5% to 75% by weight of fibers in the case of a fibrous layer or layers formed from aerogel(s)), said product comprising less than 0.55% by weight of hydrophobizing agent(s) or compound(s) (grouping together the silicone(s) and the hexamethyldisilazane), advantageously less than 0.5%, in particular less than 0.4%, in particular less than 0.25%, in particular less than 0.1%, or even less than 0.05% by weight of hydrophobizing agent(s), and preferably being devoid of hydrophobizing agent(s).

Aerogels are known as insulators in other applications, these aerogels being in particular in the form of translucent granules or fine powder, and being effective at ambient temperature in terms of thermal insulation, these aerogels possibly being used in mats (or laps) formed from entangled fibers. These aerogels are difficult and expensive to obtain on an industrial scale, requiring difficult drying conditions and are sensitive to water that can degrade their thermal insulation properties, in particular over time. They thus conventionally comprise hydrophobizing components resulting from the aerogel synthesis process and/or from the additives added during the production of these insulators. Surprisingly however, the present invention has demonstrated that the removal of these hydrophobizing agents or the absence of these hydrophobizing agents in aerogel-based insulators for use in ovens does not significantly affect the insulating properties of these insulators at the temperatures used during this application, the insulation obtained being particularly satisfactory and improved compared with that obtained with the insulators for conventional ovens. Also surprisingly, the use of these products according to the invention makes it possible to improve the performance levels in terms of energy consumption of the ovens equipped with these products. In addition, these products or the ovens equipped with these products do not have any risk of emission of toxic products, this being from the first time they are used.

The insulating product used according to the invention can be obtained directly or from existing products (comprising hydrophobizing agents), these products having been, in this case, “dehydrophobized” (the hydrophobizing agents having been limited or preferentially removed or destroyed, for example by calcination as explained below).

Thus, a possible and satisfactory process for obtaining an insulating product according to the invention from existing products comprises at least one step of extracting the hydrophobizing, agent(s) (or step of “dehydrophobizing”) of an insulating material based on aerogel(s) or of a product incorporating said material (in particular of a commercial product), said material or said product comprising in particular from 25% to 95% by weight of aerogel(s). This extracting step is carried out in particular by subjecting said product or material to a heat treatment (or calcination (step)) at a temperature of at least 320° C., preferably of at least 350° C., and advantageously less than 550° C., in particular less than 450° C., for at least 10 hours, and preferably for at least 12 h, and advantageously for less than 20 h, so as in particular to calcine or destroy, totally or at least partly, the hydrophobizing agents present, in particular such that the content of hydrophobizing agent(s) in the product or the insulating material based on an aerogel(s) is/becomes less than 0.55% by weight (relative to the weight of said product or material), advantageously less than 0.5%, in particular less than 0.4%, in particular less than 0.25% in particular less than 0.1%, or even less than 0.05% by weight, or even zero.

This treatment process makes it possible to transform commercial aerogels in order to make them compatible with use as thermal insulators in cooking ovens according to the invention, in particular in the heating boxes of said ovens, this transformation not causing any prejudicial degradations, as previously indicated.

The use of the product according to the invention, obtained directly or by treatment of already existing products (consisting of the removal or the extraction of certain selected components being used or having been used for the production of the aerogels), thus does not prevent good thermal insulating properties from being obtained and also makes it possible to improve the performance levels of the ovens compared with those of the ovens, using usual insulators made of mineral fibers, while at the same time complying with the requirements in terms of safety, health and the environment.

In particular, it is noted that the product or the oven equipped with the product remains below the threshold of emission of volatile organic compounds (VOCs) that is expected in this use, this being from the first time it is used (the insulator according to the invention thus being ready to use and able to be inserted into the ovens without prior treatment), in particular advantageously has a formaldehyde (or formol) emission of less than or equal to 10 mg/kg (that is to say less than or equal to 10 mg of formol emitted/released per kg of said insulating product), in particular less than or equal to 8 mg/kg, preferably less than 5 mg/kg, or even less than 3 mg/kg, this emission being measured according to standard NF EN 120 and corresponding approximately to the maximum emission over the course of 12 hours reached by the insulator during any heating process cooking, pyrolysis of the oven equipped with said insulating product, the heating temperature being between 50° C. and 550° C. (and in practice being generally between 50 and 240° C.).

The thermal insulating product according to the invention also has good fire resistance, good mechanical strength and good durability (or resistance to aging). It has in particular a class Al of fire resistance according to standard EN 13501-1, and a thermal conductivity of less than 50 mW/m.K, preferably less than 40 mW/m.K, or even less than 35 mW/m.K at the temperature of 200° C. (the thermal conductivity being measured according to standard ISO 8302), this conductivity also being much lower at ambient temperature. Advantageously, the insulating product according to the invention also has a thermal conductivity of less than 50 mW/m.K, in particular less than 40 mW/m.K, at 300° C., and also a thermal conductivity of less than or equal to 60 mW/m.K, in particular less than 55 mW/m.K, at 400° C.

The aerogel-based material forming the structure of the product according to the invention can integrate aerogels which are in various forms (in particular in bead or particle forms) or which are synthesized in different ways.

Aerogels are generally obtained from a get, produced for example by hydrolysis in the presence of a solvent, then gelling with catalysis using a precursor, then by evaporation or extraction of the liquid forming the gel (for example under supercritical or subcritical conditions) in order to replace said liquid with a gas (in particular air) without the porous structure collapsing. The aerogels thus formed are highly porous materials, with open pores, and the pore size of which is nanometric.

The aerogels present in the product according to the invention are advantageously inorganic aerogels, in particular based on oxides, such as aerogels based on silica, on aluminum and/or on titanium. Preferably, the product according to the invention comprises at least one silica aerogel as aerogel(s), and preferably comprises essentially (for at least 50%, and preferably for 100%, by weight of the aerogels) or only silica aerogels.

Advantageously, whether the product or material formed from an aerogel or aerogels according to the invention is formed from one or more insulating parts or layers based on aerogel(s), each part or layer preferably has a content of aerogel(s) of between 25% and 95%. and preferably of between 40% and 85% by weight of said part or layer or part, the content of aerogel(s) in the insulating (final) product according to the invention also being advantageously between 25% and 95% (by weight of the product), preferably between 40% and 85%.

Preferably, the material or materials or layer or layers based on aerogel(s) that are used or treated and that form the structure of the insulating product according to the invention are one or more fibrous layers (or layers formed from fibers), in particular of the type of a mat or mats (or pad or lap or laps formed from fibers (in particular threads and/or filaments) that are entangled), forming a porous or “discontinuous” structure containing aerogels. Each fibrous layer can be formed in a known manner, for example by depositing fibers, from a die or from another fibering device (in particular obtained by centrifugation and then drawing), on a carpet, and optionally joining the fibers together by mechanical attachment, in particular by needling, or by chemical bonding by means of a bonding agent applied to the fibers. The aerogels can be integrated into the fibers in various ways, either by mixing with preformed aerogels (produced independently of the fibrous layers), or by impregnation of the fibrous, layers with or in a solution making it possible to form the aerogels in situ, for example by impregnating the layers with (a solution containing) the reagents which make it possible to obtain the aerogels, extraction of the liquid and gelling being carried out (in particular under supercritical conditions) in order to obtain insulating layers containing aerogels. Examples of layers, or mats, of aerogels (reinforced with fibers) produced by impregnation are in particular mats of aerogels sold under the reference Spaceloft® or Cryagel by the company Aspen Aerogel Inc.

Each fibrous layer can be formed from various types of (inorganic and/or organic) fibers. Preferably, fibrous layers are chosen such that a majority (at least 50% by weight, in particular at least 75% or at least 80% by weight of the fibers), or even advantageously all, of the fibers of each layer are inorganic/mineral fibers, these fibers possibly in particular being chosen from glass fibers (or glass wool), rock fibers (or rock wool), ceramic fibers, basalt fibers, etc., and preferably being glass fibers (for example of E- or C-glass), or rock fibers Where appropriate, it is possible to have a small proportion of organic fibers (such as polyethylene, polypropylene, polyacrylonitrile, polyamide, aramid, polyester, polylactic acid, ethylene polyterephthalate (PET), etc., fibers).

The fibrous layers used where appropriate are advantageously porous and breathable, that is to say permeable to the diffusion of water vapor and of air. They preferentially (each) have a density (or voluminal mass) of between 8 and 90 kg/m³, in particular between 20 and 90 kg/m³, in particular of about from 30 to 80 kg/m³.

Since the commercially available aerogel-based materials generally comprise, in addition to the aerogels and where appropriate the abovementioned fibers, organic components resulting from their production, such as hydrophobizing agents as previously seen, the product according to the present invention also selects the aerogel-based material or layer(s) forming it in that they necessarily comprise less than 0.55% of hydrophobizing agent(s) with a view to their use in ovens, as indicated according to the invention, such materials or layers possibly being obtained directly by removing or limiting recourse to hydrophobizing agents during the production of these materials in order to obtain the required contents or by using the treatment process mentioned according to the invention starting from the commercially available aerogel-based materials or layers.

As already indicated, it is common practice, in the usual processes for obtaining aerogel-based materials intended for thermal insulation (mainly walls of buildings or optionally of containers or pipes), to add a hydrophobizing agent, mainly silicone or hexamethyldisilazane, to the initial composition making it possible to obtain the aerogels or during the synthesis of said aerogels or to the product resulting from said synthesis, the hydrophobization (or operation aimed at making the material hydrophobic) with the hydrophobizing agent having in particular the objective of improving the resistance to aging of the product obtained and/or being considered as making it possible to contribute to the obtaining of a low thermal conductivity. The content of hydrophobizing agent(s), in particular of silicone, and/or of hexamethyldisilazane, in the aerogel-based materials obtained, in particular in the commercially available aerogel-based materials for thermal insulation (generally of walls of buildings), can thus range up to 10% by weight (relative to the weight of the aerogel-based material(s)).

The term “hydrophobizing agent” is intended to mean an agent (or additive or compound) formed, where appropriate, from one or more components, making it possible to render the product incorporating it hydrophobic, this hydrophobization capacity being in particular evaluated by measuring the water absorption (water absorption value expressed in kg/m² according to standard EN 1609 or in percentage according to standard ASTM C1511). According to the invention, the content of hydrophobizing agent(s) present relative to all of the compounds present (on a dry basis/relative to the dry extract) in the product according to the invention is advantageously (made or chosen to be) less than 0.55%, advantageously less than 0.5%, in particular less than 0.4%, in particular less than 0.25%, in particular less than 0.1%, or even less than 0.05% by weight, or even zero, these agents being the abovementioned silicone and/or hexamethyldisilazane. Advantageously, the content of hydrophobizing agent(s) in each part of the product according to the invention (including the material formed from aerogel(s)) is also less than 0.55%, advantageously less than 0.5%, in particular less than 0.4%, in particular less than 0.25%, in particular less than 0.1%, or even less than 0.05% by, weight, or even zero. As previously indicated, reducing this content of hydrophobizing agent(s) not only has no significant impact on the thermal insulation properties and/or the resistance to aging of the product obtained, under the conditions under which it is used in ovens, even after several cooking cycles, but the oven thus equipped exhibits better yields and the level of emission of formal, advantageously of VOCs, also remains less than or equal to 10 mg/kg (measured according to standard NF EN 120 measurement method with hot tube at 350° C.). As previously indicated, these effects are particularly surprising since it is conventionally considered that the hydrophobizing agent is essential for guaranteeing low aerogel conductivity (the aerogel then being protected against the absorption of water at ambient, temperature, which absorption would no longer make it insulating/would make it conductive).

Each insulating layer or material used, in addition to the fact that it has a limited content of hydrophobizing agent, is also advantageously essentially (or even solely) mineral. The content of organic components present (evaluated in particular by measuring the weight of the material before and after calcination) is advantageously less than 5.5%, in particular less than 3%, preferably less than 1.65%, by weight of the product (and can also be reduced by the abovementioned process). The material or the layer can, where appropriate, comprise a binder (which is in particular aqueous-based, this binder possibly, where appropriate, comprising various organic or inorganic compounds (resin(s), additive(s), etc.)), at a content of less than 10% by weight of dry matter relative to the material to the layer, this binder making it possible where appropriate in a fibrous layer to bind the fibers together. Inorganic fillers and/or one or more additives, preferably inorganic additives, at contents not exceeding 5% by weight, can optionally be present in the product according to the invention, in particular when one or more properties and/or functions are desired (presence for example of an opacifier).

The product according to the invention (or each insulating material or layer containing aerogels) generally comprises (or is formed) from 25% to 95% (in particular from 40% to 85%) by weight of aerogel(s) (preferably inorganic aerogel(s)), and where appropriate from 5% to 75% (in particular from 20% to 40%) by weight of fibers, preferably (for at least 50% by weight, and advantageously up to 100% by weight, of them) inorganic fibers (in particular glass or rock fibers). This product is preferably of limited thickness, its thickness not exceeding 50 mm, and being advantageously less than 35 mm (the thickness of each layer, where appropriate, possibly being between 5 and 35 mm).

The product according to the invention is generally formed from a single type of aerogel-based material or from a single insulating layer (with optional surfacing), but it can also comprise several insulating parts or layers, which am bonded for example by adhesive bonding or are superimposed, this product possibly being more or less dense (for example having a density of between 100 kg/m³ and 250 kg/m³), the fibers forming as appropriate this product (in addition to the aerogels) being preferentially (predominantly, at at least 80% by weight of the fibers) E- or C-glass fibers (and optionally comprising a low proportion of organic fibers, in particular of PET type). The product according to the invention can be accompanied, where appropriate, by its surfacing, for example a glass veil, in particular for limiting dust and/or can be covered on its edge(s) with adhesive tape, for example made of aluminum, for the same reason.

The insulating product according to the invention is generally in (semi-)rigid form and can be attached on or around the walls or elements to be insulated by various means (adhesive bonding, stapling, screw-fixing, hoop binding, etc.).

It is advisable in particular to insulate all or part of the heating box of the ovens (whether this is the door, the back face or the side faces, also called belt), and/or to insulate and protect certain elements of the oven (such as lamps). The insulator is placed in particular around or on the walls or the elements in question.

The thermal performance levels of the insulator according to the invention result in values of thermal conductivity A that are advantageously less than 50 mW/m.K, preferably less than 40 mW/m.K, or even less than 35 mW/m.K at the temperature of 200° C. (this conductivity being even lower at ambient temperature), advantageously less than 50 mW/m.K, or even less than 40 mW/m.K, at 300° C., and particularly advantageously less than or equal to 60 mW/m.K, or even less than 55 mW/m.K, at 400° C., The thermal conductivity A (in W/m.K) represents the amount of heat passing through the insulator (one meter thick, per m²). The values of thermal conductivity A (compared at identical pressure, in particular at atmospheric pressure (1 bar) and identical temperature) are measured by means of the guarded hot plate method (standard ISO 8302).

The product according to the invention exhibits a good compromise in terms of thermal conductivity, VOC emission and fire resistance, and meets the hygiene and safety requirements. The amount of formol emitted is measured in particular in the present invention according to standard NF EN 120 (in particular by placing 10 g of sample in a tube oven at 350° C., a gas stream of reconstituted air passing through the sample for 1 h, the formal given off being trapped in 2 bubblers in series filled with 50 ml of water, and the accumulative amount thereof in the 2 bubblers being measured by the Lange method), by carrying out the measurement on a Hermann Moritz tube oven. The formol content of the product according to the invention is less than 10 mg, or even less than or equal to 8 mg of formol per kg of product, preferably less than 5 mg/kg, or even less than 3 mg/kg.

The process for obtaining the product can, where appropriate, comprise a finishing and conditioning step, and/or a cutting step. It is in particular possible to recut the edges of the insulating product or to cut the layer(s) or material(s) containing the aerogels to the, required dimensions. A coating material can, where appropriate, be applied at the surface in order to protect the product or to reinforce it, for example a veil, scotch tape, a coating, etc.

The device or appliance according to the invention is preferably an oven, or even a part of an oven, in particular a cooking enclosure, in particular for domestic use or optionally another use (for example for industrial use), in which the temperatures can occasionally reach 450° C. for example, or even 550° C. or even optionally higher, this device comprising or being coated with at least one insulating product as previously defined. Advantageously, the device according to the invention comprises, as insulating product(s), only one or more of the abovementioned insulating products according to the invention.

The present invention and the advantages thereof will be understood more clearly on reading the examples which follow, which are given only by way of illustration and which cannot in any way be considered to be limiting.

In the example according to the invention, a product was formed from an insulating pad in the form of a mat impregnated with silica aerogels analogous to the products of Pyrogel® XT-E type sold by the company Aspen Aerogel Inc., this pad having a density of 0.20 g/cm³. The product formed according to the invention is solely formed from impregnated mat and has a thickness of 20 mm. It is then heat treated at 350° C. for 12 h. Monitoring of the volatile species at the end of the treatment showed that the final product has a final composition containing less than 0.2% of hydrophobizing agent.

The thermal conductivity measurement was carried out according to the principle of the guarded hot plate according to standard ISO 8302 at a temperature of 200° C. and at atmospheric pressure.

The amount of formol emitted was measured on a Hermann Moritz tube oven according to standard NF EN 120.

The results obtained were the following:
thermal conductivity A at 200° C.: 30 mW/m.K
thermal conductivity A at 300° C.: 39 mW/m.K
formol emission per kg of product: 10 mg/kg

The thermal conductivity of this product was compared to that obtained with a usual product for insulating ovens, formed from a mineral wool (reference example), this product being for example the product sold under the reference TNF80120 by the company Saint-Gobain Isover France, the thermal conductivity obtained for this usual product at 200° C. being about from 55 to 70 mW/m.K and that obtained for this usual product at 300° C. being about 75 mW/m.K.

An oven, of reference De Dietrich CZ5702359 sold by the company Brandt, was also equipped with an insulating interior belt using, firstly, to form this belt, the standard product according to the reference example, and then replacing it with the product according to the invention according to the example, and the consumption of the ovens was measured according to standard EN 60350. The measurements of the heating at the core of the element to be heated were carried out on a brick sold under the reference Hipor by the company Skamol, the brick having been predried, then immersed in a water bath placed in a refrigerator for at least 8 hours until a brick temperature (measured in the brick by two thermocouples) of 5° C. was obtained, the brick saturated with water and drained for approximately 1 min then being placed at the center of the oven.

The energy consumption of the oven was measured for two cooking positions, the ambient temperature of the oven environment being approximately 23° C., a conventional position according to standard EN 60350 with heating of about 140° (corresponds to a temperature at the center of the oven of 163° C. (140° C. heating relative to 23° C. of ambient temperature)), 180° and 220°, and a forced ventilation position according to standard EN 60350 with heating of 135° C. 155° and 175°, the test ending when the last of the two thermocouples present in the brick indicates a heating of 55° (absolute temperature of 60° C., the initial temperature of the brick being 5° C.). The arithmetic mean of the energy consumptions for each heating temperature was then calculated, in accordance with standard EN 60350.

In the case of the oven having an insulating belt formed from the standard product according to the reference example, the oven consumption was 760 Wh, and in the case of the oven having an insulating belt formed from the product according to the invention according to example 1, the oven consumption was 630 Wh.

The results obtained show that the use of the products according to the invention for insulating domestic ovens or for other uses at high temperature makes it possible to obtain, for the ovens that these products equip, improved energy performance levels, the absence of hydrophobizing agent or the calcination of the hydrophobizing agent by heat treatment not resulting, in addition, in a degradation of the thermal performance levels of the insulator, said insulator having insulating performance levels that are particularly satisfactory even at high temperature, the emission of formol or VOC being in addition particularly limited despite the temperatures during use (10 mg/kg of formol being an acceptable limit for being able to be used in cooking ovens).

By comparison regarding the latter point, a product was formed from a mat impregnated with aerogels of Pyrogel® XT-E type analogous to that of the example according, to the invention, but which had not undergone heat treatment. The analysis of its organic matter content was typical of a composition containing more than 1% by weight of hydrophobizing agent. For this product, a thermal conductivity A 28 mW/m.K at 200° C. and a formol emission per kg of product of greater than 500 mg/kg, which is much too high for use in a domestic cooking oven, were obtained. In the same way, with a less drastic heat treatment of the product (at 200° C. for 12 h), the analysis of the product was typical of a composition still containing more than 1% by weight of hydrophobizing agent and, for this product, a thermal conductivity A 30 mW/m.K at 200° C. and a formol emission per kg of product of 150 mg/kg, also too high for use in a domestic cooking oven, were obtained. Conversely, a product resulting from a heat treatment at 500° C. for 12 h revealed an analysis typical of a composition containing less than 0.1% of hydrophobizing agent (example in accordance with the invention) and, for this product, a thermal conductivity λ=34 mW/m.K at 200° C. and a particularly satisfactory, formol emission per kg of product of 2 mg/kg were obtained.

The insulating product used according to the invention is in particular suitable for insulating walls or components of domestic electrical ovens, but can also be used to advantage for the thermal insulation of any other surface, in particular for high-temperature applications (or for insulating products subjected to high temperature).

1. A device, which operates at high temperature up to 550° C., such as an oven or a part of an oven, the device comprising:
at least one insulating product formed from at least one insulating material based on aerogel(s), advantageously in the form of at least one layer, in particular of at least one fibrous layer, based on aerogel(s), said product comprising less than 0.55% by weight of hydrophobizing agent(s).

2. The device as claimed in claim 1, wherein said product comprises less than 0.5% advantageously less than 0.4%, or even less than 0.25%, in particular less than 0.1% or even less than 0.05% by weight of hydrophobizing agent(s), and preferably is devoid of hydrophobizing agent(s).

3. The device as claimed in claim 1, wherein the content of organic components in the insulating product is less than 5.5% by weight of said product, in particular less than 3%, preferably less than 1.65%, said product advantageously being solely mineral.

4. The device as claimed in claim 1, wherein the insulating material comprises from 25% to 95% by weight of aerogel(s).

5. The device as claimed in claim 1, wherein the insulating material is formed from at least one fibrous insulating layer containing aerogels, said layer comprising from 25% to 95% by weight of aerogel(s) and from to 75% by weight of fibers, said fibrous layer having in particular density of between 8 and 90 kg/m3, its thickness being in particular between 5 and 35 mm, said fibrous layer preferentially being a mat based on E- or C-glass fibers.

6. The device as claimed in claim 1, wherein the insulating product has a formaldehyde emission of less than or equal to 10 mg/kg, in particular less than or equal to 8 mg/kg, preferably less than 5 mg/kg, or even less than 3 mg/kg.

7. An insulating product, suitable for the thermal insulation of high-temperature devices, in particular of devices as claimed in claim 1, said product being formed from at least one insulating material based on aerogel(s), advantageously in the form of at least one layer, in particular of at least one fibrous layer, based on aerogel(s), said product comprising less than 0.55% by weight of hydrophobizing agent(s), advantageously less than 0.5%, in particular less than 0.4%, or even less than 0.25%, in particular less than 0.1%, even less than 0.05% by weight of hydrophobizing agent(s), and preferably being devoid of hydrophobizing agent(s).

8. The insulating product as claimed in claim 7, wherein the thermal conductivity of said product less than 50 mW/m.K at 200° C., advantageously less than 50 mW/m.K at 300° C., and particularly advantageously less than or equal to 60 mW/m.K at 400° C.

9. The use of an insulating product as claimed in claim 7, for the insulation at high temperature, in particular of a device subjected to temperatures of up to 550° C., and in particular between 50 and 350° C.

10. A process for obtaining insulating product as claimed in claim 7, said process comprising at least one step of extracting, in particular of calcinating, the hydrophobizing agent(s), of an insulating material formed from aerogel(s) or of a product incorporating said material, in particular such that the content of hydrophobizing agents in the insulating product or material formed from aerogel becomes less than 0.55% by weight, or even such that the product or material is devoid of hydrophobizing agents, said material or said product comprising particular from 25% to 95% by weight of aerogel(s).

11. The process as claimed in claim 10, wherein the extraction step is carried out by subjecting said product or material to a heat treatment temperature of at least 320° C., preferably of at least 350° C. and advantageously less than 550° C., in particular less than 450° C., for at least 10 hours, and preferably for at least 12 h.

12. The device according to claim 1, wherein the device operates at a temperature between 50° C. and 350° C.
